(19) United States
(12) Patent Application Publication
(10) Pub. No.: US 2013/0020178 A1
(43) Pub. Date: Jan. 24, 2013

(54) COAL CHUTE WITH BELT SCRAPER

(71) Applicant: Prairie Machine & Parts Mfg. (1978) Ltd., Saskatoon (CA)

(72) Inventor: Maurice Demong, Wakaw (CA)

(73) Assignee: Prairie Machine & Parts Mfg. (1978) Ltd., Saskatoon (CA)

(21) Appl. No.: 13/625,643

(22) Filed: Sep. 24, 2012

Related U.S. Application Data
(63) Continuation of application No. PCT/CA2011/000305, filed on Mar. 24, 2011.

(30) Foreign Application Priority Data
Mar. 24, 2011 (CA) 2697778

(51) Int. Cl. B65G 47/44

(52) U.S. Cl. 198/499

(57) ABSTRACT

A discharge chute and belt scraper for use at a head pulley end of a conveyor belt includes a chute (72) having a receiving end (74) and an opposite discharge end. The receiving end can be mounted adjacent the head pulley end of the belt. The belt scraper (82) is mounted on this receiving end so that the scraper will extend at least a major part of the width of the belt. Chute supporting members (100, 102) are arranged at opposite sides of the chute member. Link members (104, 106) pivotally connect each of the opposite sides of the chute to a respective one of the supporting members so that the receiving end of the chute is movable towards or away from the head pulley end. Coil springs (132, 134) bias the receiving end of the chute and the belt scraper towards the head pulley end.

### CROSS-REFERENCE TO RELATED APPLICATIONS

This application is a continuation of PCT/CA2011/000305 filed Mar. 24, 2011, which claims priority of Canadian Patent Application 2,697,778 filed Mar. 24, 2010.

### FIELD OF THE INVENTION

This invention relates to belt type conveyors, particularly those used to transport basic materials such as coal, discharge chutes for these conveyors and conveyor belt cleaners adapted to remove material that sticks to a conveyor belt at its discharge end.

### BACKGROUND OF THE INVENTION

Conveyors that utilize an endless loop conveyor belt to transport bulk material, such as coal, sand, gravel and similar materials from one location to another are well known. The conveyor belt can be supported by means of a series of conveyor rollers along its length and the ends of these rollers are supported on an elongate belt supporting frame. Located at each end of the conveyor, there is a rotating drum or pulley which both supports the end of the loop and provides the means for reversing the direction of movement of the belt. A well known difficulty with belt conveyors of this type is that when the bulk material is discharged from the downstream end of the conveyor, a portion of the bulk material tends to remain adhered to or stuck to the outwardly facing surface of the conveyor belt.

A number of conveyor belt cleaners have been developed for conveyors of this type, these cleaners employing one or more blades that are mounted to scrape the outer surface of the belt as it passes by.

Recent U.S. Pat. No. 7,216,756 which issued May 15, 2007 to Martin Engineering Company describes a tensioner for maintaining engagement of a conveyor belt cleaner with a conveyor belt, the cleaner including one or more scraper blades mounted on a rotatable support frame. The tensioner includes a mounting member attached to the support frame for a rotation therewith, a biasing member attached to the mounting member, and an actuator attached to the biasing member. Operation of the actuator stores a biasing force within the biasing member which in turn rotates the scraper blades into full-face engagement with the conveyor belt. The mounting member can be a pulley connected to one end of the tubular support frame and also to one end of a flexible cable which is connected at its opposite end to the tensioner that includes a coil spring.

International PCT Published Patent Application No. WO 2008/095302 published on Aug. 14, 2008 describes a low profile conveyor system that includes a train of conveyor vehicles with each vehicle having a pair of steerable wheels and its own conveyor belt, the upper surface of which extends at a relatively small angle to the horizontal. Each vehicle has an elongate supporting frame with two longitudinal side frame members on opposite sides thereof and two end sections between which the conveyor belt extends. Adjacent conveyor vehicles are connected together by means of a hitch unit. An endless loop conveyor belt extends between a tail pulley unit mounted adjacent one end of each vehicle and a head pulley mounted adjacent the opposite end. An electric motor drives the head pulley in order to move the top surface of the conveyor belt to the discharge end of the vehicle. Mounted adjacent the head pulley at the discharge end is a material hopper or chute which directs the material onto the conveyor belt of the next conveyor vehicle. It is known to provide a belt scraper mounted adjacent to the head pulley to help keep the conveyor surface of the belt clean. However difficulties have been encountered with these known belt scrapers and there is a need to provide an improved scraping system for the conveyor belt, particularly when the train of conveyor vehicles is used to convey a bulk material such as coal.

### SUMMARY OF THE INVENTION

According to one embodiment of the present invention, a discharge chute and belt scraper combination for use at a head pulley end of a conveyor belt movably mounted on a belt supporting frame includes a chute member having a receiving end and an opposite discharge end and opposite sides. The receiving end is adapted for mounting adjacent the head pulley end of the conveyor belt. A belt scraper is mounted on the receiving end so that, during use of the combination, the scraper extends substantially across the width of the conveyor belt. The combination also includes chute supporting members arranged at the opposite sides of the chute member and adapted for mounting on the belt supporting frame. A movable link mechanism pivotally connects each of the opposite sides of the chute member to respective one of the chute supporting members whereby the receiving end of the chute member is movable towards or away from the head pulley end of the conveyor belt. There is also a spring mechanism biasing the receiving end of the chute member and the belt scraper towards the head pulley end of the conveyor belt during use of the combination so that the belt scraper scrapes the conveyor belt at the head pulley end.

In an exemplary version of this discharge chute and belt scraper combination, the movable link mechanism include a pair of parallel link members on each of the opposite sides of the chute member with each link member being pivotably connected at one end to the adjacent side of the chute member and being pivotably connected at its other end to its respective chute supporting member.

According to another embodiment of the present invention, a discharge chute apparatus for a conveyor belt having a discharge end and being mounted on a conveyor belt supporting structure includes a chute member having opposite first and second ends and opposite sides. The first end is adapted for mounting adjacent to the discharge end of the conveyor belt and extends substantially the width of the discharge end. This first end is adapted for mounting a belt scraper transversely relative to the length of the conveyor belt. Two chute supporting members are arranged at the opposite sides of the chute member and are adapted for mounting on the supporting structure. Link members pivotably connect each chute supporting member to a respective one of the two opposite sides of the chute member so that the chute member is movably supported by the link members and the chute supporting members. Thus the first end of the chute member is movable towards or away from the discharge end of the conveyor belt. The apparatus further includes a biasing arrangement biasing the first end of the chute member towards the discharge end of the conveyor belt. During use of the apparatus with the conveyor belt when a belt scraper is mounted on the first end of the chute member, the belt scraper is biased so as to engage and scrape the discharge end of the conveyor belt.

In an exemplary version of this discharge chute apparatus, the biasing arrangement includes two elongate coil springs, each having one end connected to one of the link members on a respective side of the chute member.

According to a further embodiment of the present invention, a belt-type conveyor apparatus for conveying a material such as coal includes an endless loop conveyor belt and a conveyor belt support structure having an elongate supporting frame, belt supporting rollers mounted along the length of the supporting frame, and a head pulley rotatably mounted at one end of the supporting structure. The conveyor belt is mountable on the supporting rollers and is extendable around the head pulley. A discharge chute member has a receiving end adjacent the head pulley and two longitudinal sides and the receiving end is adapted for mounting a belt scraper. Chute supporting members are mounted on the supporting frame at the head pulley end. The conveyor apparatus further includes pivotable link members for pivotably connecting the chute member to the chute supporting members whereby the receiving end of the chute member is movable towards or away from the head pulley. A spring arrangement is provided that biases the receiving end of the chute member towards the head pulley wherein, during use of the conveyor apparatus with a belt scraper mounted on the receiving end of the chute member, the belt scraper is able to scrape the conveyor pulley.

These and other aspects of the discharge chute apparatus and conveyor apparatus of the invention will become more readily apparent to those having ordinary skill in the art from the following detailed description taken in conjunction with the drawings provided herewith.

### BRIEF DESCRIPTION OF THE DRAWINGS

So that those having ordinary skill in the art to which the present disclosure pertains will more readily understand how to make and use the subject invention, exemplary embodiments thereof will be described in detail herein below with reference to the drawings, wherein:

FIG. 1 is a top view of one embodiment of a mobile conveyor machine or vehicle of known prior art construction;

FIG. 2 is a side elevation of the conveyor vehicle of FIG. 1;

FIG. 3 is a perspective view of one embodiment of a discharge chute apparatus mounted at the downstream end of a mobile conveyor machine, only a portion of which is shown, this view being taken from above and from one longitudinal side of the machine;

FIG. 4 is an end view of the discharge chute apparatus of FIG. 3 shown mounted adjacent a head pulley of the conveyor machine;

FIG. 5 is a cross-sectional elevation of the head pulley shown in FIGS. 3 and 4, this view being taken along the line V-V of FIG. 6;

FIG. 6 is a top view of the discharge chute apparatus and adjacent head pulley;

FIG. 7 is a side view of the discharge chute apparatus shown from the left side of FIG. 6;

FIG. 8 is a bottom view of the discharge chute apparatus and the adjacent head pulley;

FIG. 9 is a detail cross-sectional view of the encircled area indicated at IX in FIG. 5; and

FIG. 10 is a cross-sectional elevation taken along the line X-X of FIG. 8.

### DETAILED DESCRIPTION OF THE PREFERRED EMBODIMENTS

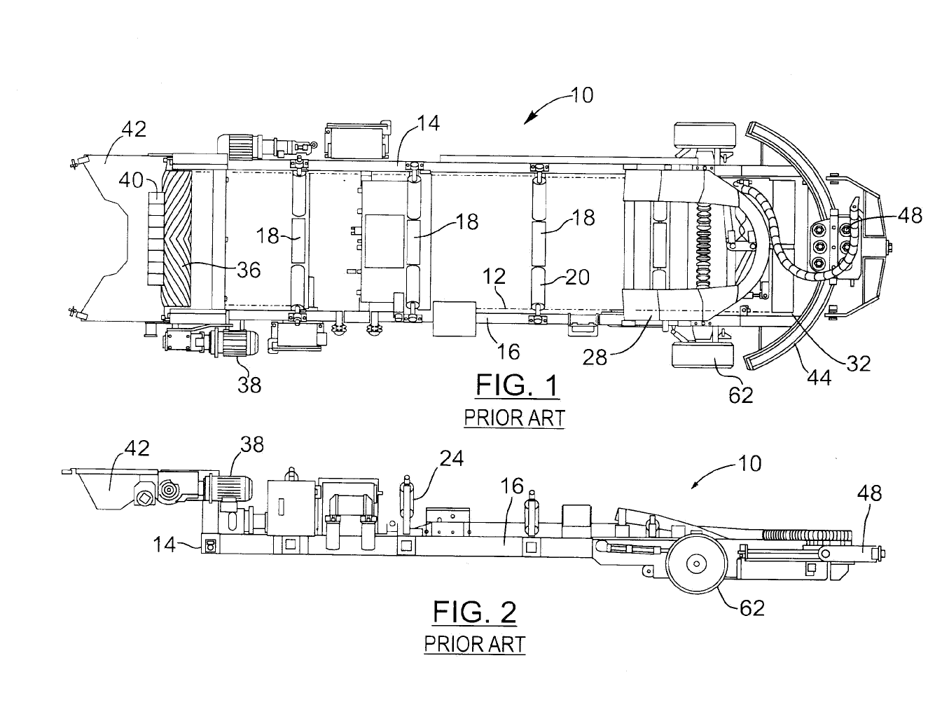

A known belt-type conveyor apparatus in the form of a conveyor vehicle 10 is illustrated in FIGS. 1 and 2. This apparatus in the form of a vehicle which can be part of a train of vehicles, is suitable for conveying bulk materials, such as coal, and a significant feature of the apparatus is that it has a low profile which permits it to be used in underground mine shafts having a relatively low ceiling. For sake of illustration, the usual flexible conveyor belt which forms an endless loop is only indicated by chain-link lines at 12 in FIG. 1. The belt itself can be of standard construction with the construction depending upon the type of material being conveyed by the conveyor system. The illustrated conveyor vehicle is intended for use as an intermediate conveyor car of which there may be five, ten or more in a trail of conveyor vehicles similar to the train illustrated and described in U.S. Pat. No. 5,366,059. It will be understood that in addition to a plurality of intermediate conveyor vehicles pivotably connected end-to-end there can also be a loading conveyor vehicle which is located at the end of the train adjacent the mining machine, and a discharge conveyor vehicle located at the opposite end of the train, which is referred to as the outby end, that is, the end to which the train of vehicles delivers the material. A loading conveyor assembly can be constructed in a manner similar to the illustrated intermediate conveyor car, except that it need not be provided with a hitch mechanism at its inby or hopper end.

The illustrated conveyor apparatus 10 has a conveyor mechanism 14 that includes an elongate, substantially horizontal frame 16, and a series of spaced apart conveyor roller devices 18 mounted on the horizontal frame 16 and adapted to support rotatably an upper run of the endless loop conveyor belt 12. The frame 16 is an elongate supporting frame having a head pulley 36 rotatably mounted on one end. The illustrated roller devices each comprise three metal rollers 20 which are pivotably connected together in an end-to-end fashion by their central shafts. The outer end of each outer roller is connected by a chain to a vertical support post 24 mounted on a longitudinally extending frame member of the supporting frame 16.

The conveyor apparatus 10 includes a tail pulley unit mounted adjacent one end of the conveyor apparatus on the frame 16 and having a rotatable tail pulley indicated at 32. The conveyor mechanism further includes a head pulley unit that includes the aforementioned head pulley 36 which, in a known manner, can be provided with a gripping cylindrical surface which enables the head pulley unit to drive the conveyor belt. The head pulley unit includes an electric motor mechanism 38 which rotates the head pulley to move the conveyor belt. Mounted adjacent to the head pulley at the outby end of the vehicle is a material chute 42 which helps direct the material onto the conveyor belt of the next conveyor vehicle of the train. Also visible in FIG. 1 is known type of belt scraper 40 mounted adjacent to the head pulley to help keep the conveying surface of the belt clean. In this known construction, the belt scraper is separate from the discharge chute and is mounted in a manner not shown to the end of the support structure of the conveyor apparatus.

This known belt scraper is available from Brelko and it comprises multiple blades which are friction mounted (slide on) to an extruded aluminum rail.

The illustrated conveyor vehicle has a low profile which is in part due to its pivoting hitch mechanism 44 at the inby end of the vehicle. This hitch mechanism includes a curved steel track and a rolling hitch device 48. The construction of this conveyor apparatus, including the hitch device are described and illustrated in published US application No. WO 2008/095302 which was published on Aug. 14, 2008. The description and drawings of this published application are incorporated herein by reference.

The conveyor vehicle 10 has a pair of transversely aligned wheel units indicated at 62, each of which is separately connected to the horizontal frame 16. Each wheel is mounted for pivotal movement about a substantially vertical pivot axis for steering purposes.

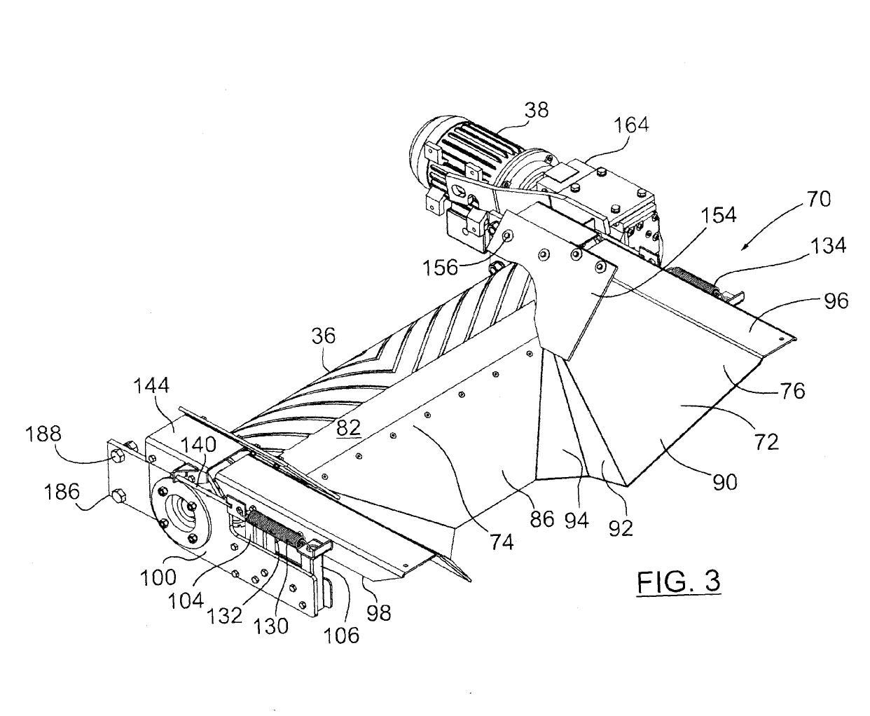

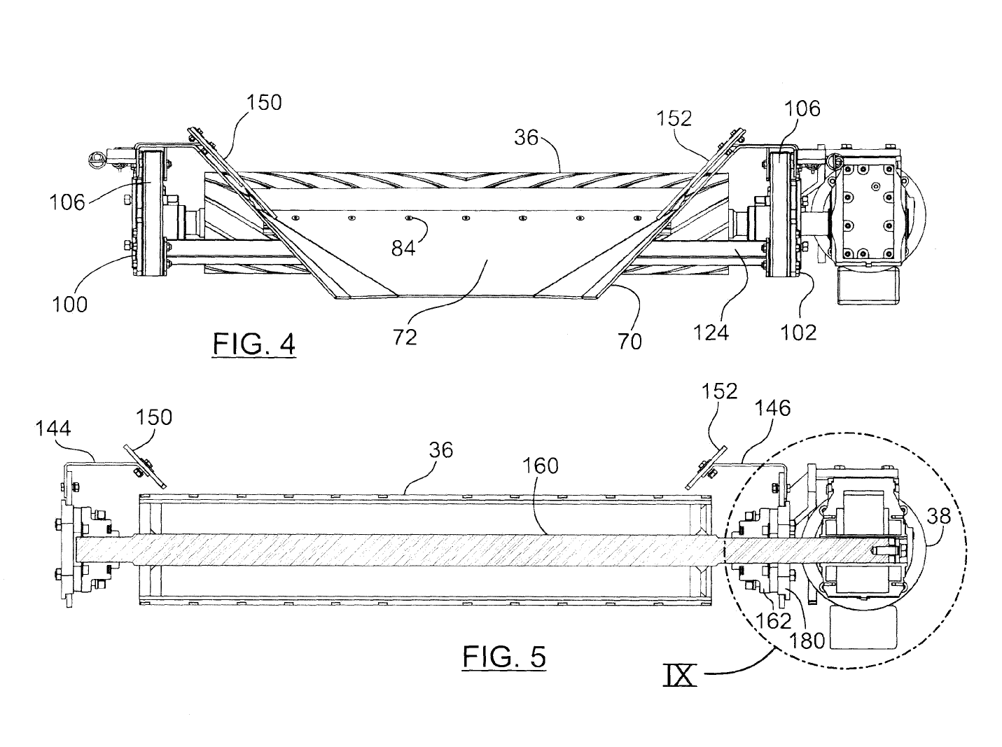

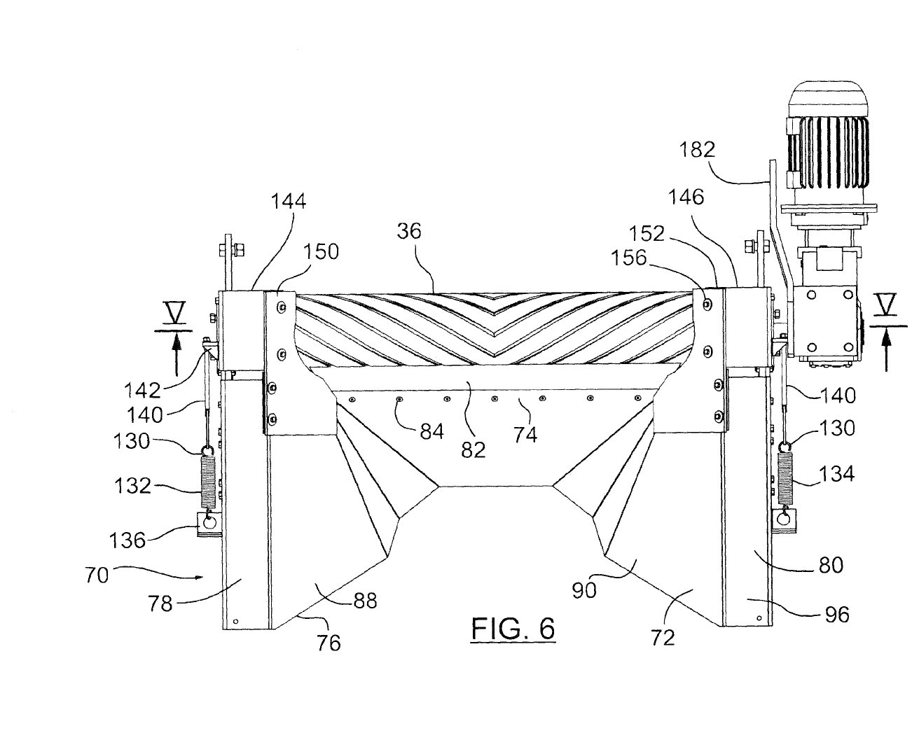

Turning now to the discharge chute apparatus for a conveyor belt according to the present invention, this apparatus 70 is adapted for mounting adjacent a discharge end of the conveyor belt 12 which is mounted on the above described conveyor belt supporting frame 16. The discharge chute apparatus includes a chute member 72 having a first end 74 and an opposite second end 76. The chute member also has two opposite side 78 and 80 that extend between the first and second ends. As shown in FIGS. 3 and 6, the first end 74 is adapted for mounting adjacent the discharge end of the conveyor belt, this discharge end extending around the head pulley 36 and extends at least a major portion of the width of the discharge end. The first end of the chute member is adapted for mounting a straight, elongate belt scraper 82 which can be in the form of an elongate, straight blade. The detachable belt scraper is attached to the first end section of the chute by a series of suitable bolt and nuts indicated at 84. In one exemplary embodiment there are seven of these bolt and nut combinations. It will be appreciated by those skilled in the art that the belt scraper is replaced from time to time as it becomes worn from use. The belt scraper 82 is mounted so as to extend transversely relative to the length of the conveyor belt 21.

The illustrated chute member 72 includes a metal central panel 86 with parallel upper and lower edges, this panel being adapted to slope downwardly from the discharge end of the conveyor belt. The chute member further includes two metal side panels 88 and 90 rigidly connected to opposite sides of the central panel. An exemplary material for central and side panels is wear resistant steel. If desired, each side panel can be formed with adjacent triangular sections, 92, 94, which extend at an obtuse angle to each other. The panel section 92 extends at a substantial angle to the main portion of the side panel.

In the illustrated exemplary embodiment, each side panel has a substantially horizontal upper edge section 96 with each section 96 extending substantially the length of the chute member 72. Each edge section can have a vertically extending edge flange 98 that can be tapered at its forward end.

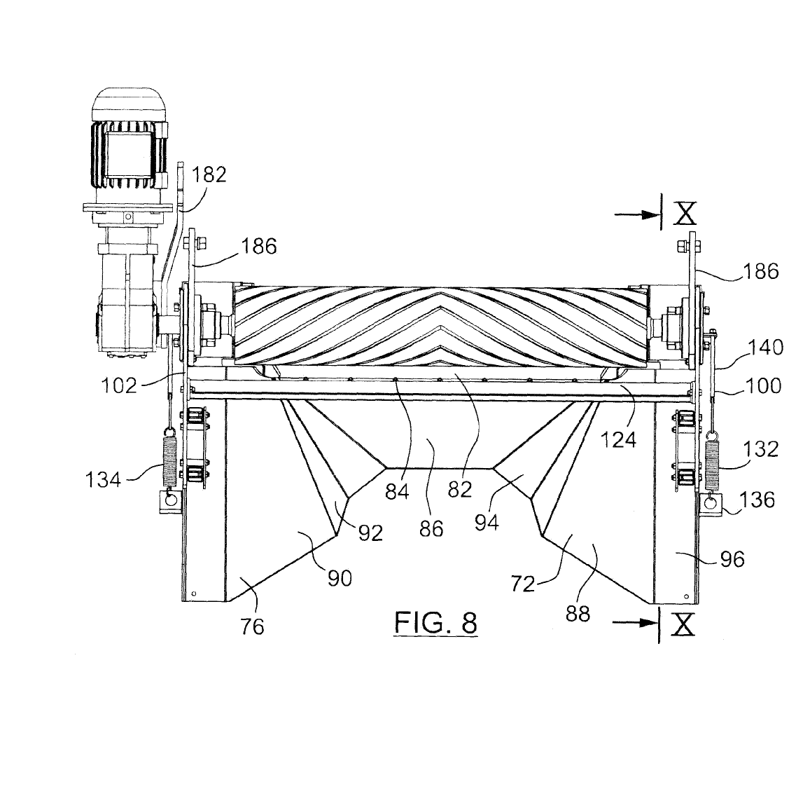

The discharge chute apparatus has two chute supporting members indicated generally at 100 and 102. These members are arranged at opposite sides of the chute member 72 and are adapted for mounting on the support structure of the conveyor apparatus. These chute supporting members can also be described as chute arms and each extends forwardly from its respective end of the head pulley, as shown. Two link members 104, 106 pivotably connect each chute supporting member 100, 102 to a respective one of the two opposite sides of the chute member 72 so that the chute member is movably supported by the link members and the chute supporting members. In this way, the first end 74 of the chute member is movable towards or away from the discharge end of the conveyor belt (or, in other words, towards or away from the head pulley about which this belt extends). The two link members on each side can be described as swing arms that are pivotally connected at their opposite ends. With reference to the detail view of FIG. 10, it will be seen that the two link members extend parallel to each other and they are connected by means of two pivot pins to the edge flange 98 of the chute member. The connection to the edge flange can be strengthened by a rectangular connecting plate 110 through which the pivot pins also extend. The bottom ends of the link members are pivotably connected by two pivot pins 112 to lower swing arm bracket 114. This bracket is spaced apart from and connected to one of the chute support members 100, 102. The latter member has a relatively narrow forward section 116 which is integrally connected to a substantially wider rear section 118. Mounted on the outer surface of the rear section 118 is a rotation stopper block 120 which limits the amount that the link members and the attached chute can move rearwardly towards the conveyor belt. The block can be mounted by means of a bolt and nut combination indicated at 122. Also visible in FIG. 10 is the end portion of a horizontal cross-brace 124 which helps add rigidity to the support structure for the chute member. The entire cross brace 124 is shown in FIG. 8 and it can be in the form of an elongate tubular member (with a square cross section) that joins together the two chute supporting members 100, 102. A rectangular mounting plate can be welded to each end of the cross brace 124 and this mounting plate can be bolted to the adjacent supporting member.

The discharge chute apparatus 70 has a biasing arrangement indicated generally at 130 which biases the first end 74 of the chute member towards the discharge end of the conveyor belt. Because of this biasing arrangement, during use of the chute apparatus when a belt scraper is mounted on the first end of the chute member, the belt scraper is biased so as to engage and scrape the discharge end of the conveyor belt.

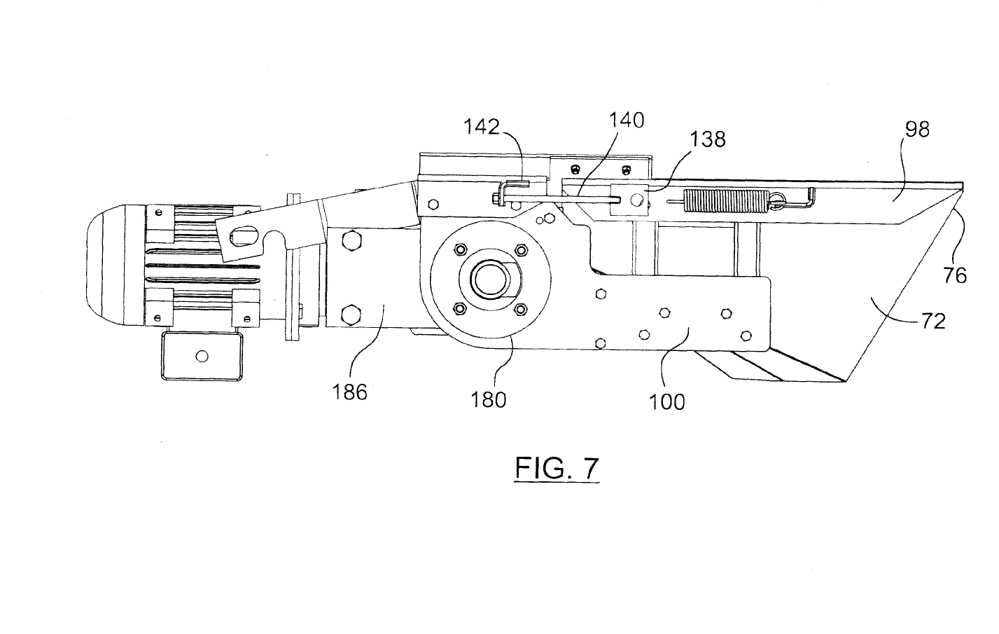

In the exemplary embodiment shown, the biasing arrangement includes two elongate coil springs 132, 134, each having one end connected to a respective one of the opposite sides of the chute member 72. The forward end of each spring can be connected to a lug 136 formed with a hole to hold an end hook of the spring. The lug is rigidly attached to the edge flange 98 formed on the adjacent side of the chute. The opposite end of the spring can be connected via a rectangular tab 138 to a threaded rod 140 forming a threaded rod weldment (see FIG. 7). The rear end of the threaded rod is connected in an adjustable manner to another lug 142 which is connected to a chute extension bracket 144 at one end of the head pulley and another chute extension bracket 146 at the gear box end of the head pulley. The threaded rod weldment (138/140) is used to apply tension to the spring 132 or 134.

An exemplary embodiment of the discharge chute apparatus is provided with two chute extension inserts 150, 152 mounted adjacent opposite sides of the chute member 72 and close to the discharge end of the conveyor belt. An exemplary form of each chute extension is made of rubber or a rubberlike material that is wear resistant and the extension has a major planar portion 154 that extends over part of the inner surface of an adjacent side wall of the chute member. As shown, the belt scraper 82 can extend between and below the two chute extension inserts. Each extension insert can be connected to the chute member by a plurality of bolt and nut combinations, as shown. In the illustrated embodiment, there are four of these bolt and nut combinations 156. Each extension insert is bolted to a respective one of the chute extension brackets 144, 146, by four bolts and each insert has a sloping connecting flange through which the connecting bolts extend.

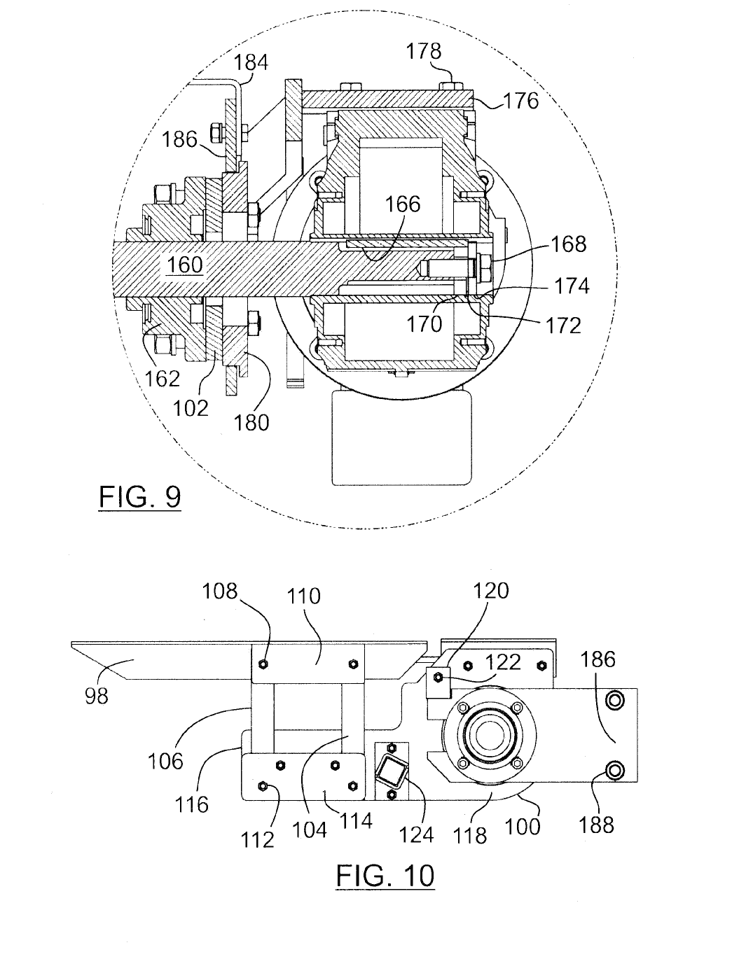

With reference now to FIGS. 5 and 9, the drive system for the head pulley and its mounting will now be explained with the understanding that the head pulley and its drive system are of standard, known construction. The head pulley 36 is hollow. Extending through the pulley is an elongate drive shaft 160 that extends through the end walls of the pulley. Each end section of the shaft is mounted in a suitable bearing 162. One form of bearing that can be used is a double row, spherical flange bearing available from Blue Brute, Part No. QMFY133207S. Connected to one end of the drive shaft is a gear box 164 which is driven by the electric motor. One suitable form of gear box is that sold by Flender, Model KAD88-K4-132. Other details shown in the detail view of FIG. 9 include a key 166 that extends in a slot formed in the end of the drive shaft 160 and a bolt 168 which is threaded into the end of the drive shaft at the gear box end. This bolt extends through a gear box spacer 170 which is positioned adjacent an internal retaining ring 172. The head of the bolt 168 engages one side of a washer 174. The gear box and motor are supported by a support bracket 176 to which the gear box is attached by bolts 178. The bracket 176 has a downward extension which is secured to a ring support 180 through which the drive shaft extends. Mounted adjacent to the ring support is the chute support member 102 formed with an aperture through which the drive shaft extends. The bearing set 162 is mounted on the inside surface of the chute support member 102. Mounted between the ring support 180 and the gear box is an elongate, slightly bent, torque arm 182, this arm extending from the inner side of the gear box to about the midpoint of the electric motor. One end of the torque arm is attached to the gear box by bolts while the other end is connected to the frame of the conveyor by being inserted over a pin welded to the conveyor frame. The end of the arm is kept on the pin by a spring pin (not shown). The chute extension bracket 146 is formed with a downwardly extending outer connecting flange 184 visible in FIG. 9 which is connected to a generally rectangular support plate 186 by suitable bolts and cooperating nuts. Each of the two support plates 186 is attached to a respective one of the chute support members 100, 102. Each support plate 186 extends rearwardly from the adjacent chute support member and is bolted to the conveyor belt support structure. The two support plates 186 also serve as a mounting plate for the head pulley. Two bolts for securing each support plate 186 are indicated at 188 in FIG. 10.

While the present invention has been illustrated and described as embodied in an exemplary embodiment, ie. an embodiment having particular utility as a discharge chute for a conveyor belt to which a belt scraper can be mounted, it is to be understood that the present invention is not limited to the details shown herein, since it will be understood that various omissions, modifications, substitutions and changes in the forms and details of the disclosed discharge chute apparatus and conveyor apparatus may be made by those skilled in the art without departing in any way from the scope of the present invention. For example, those of ordinary skill in the art will readily adapt the present disclosure for various other applications without departing from the scope of the present invention.

1. A discharge chute apparatus for a conveyor belt having a discharge end and being mounted on a conveyor belt support structure, said discharge chute apparatus comprising:
a chute member (72) having opposite first and second ends and opposite sides, said first end (74) being adapted for mounting adjacent said discharge end of the conveyor belt and extending substantially the width of said discharge end;
two chute supporting members (100, 102) arranged at said opposite sides of said chute member and adapted for mounting on said support structure, said apparatus characterized by two link members (104, 106) in the form of swing arms pivotally connecting each chute supporting member to a respective one of the two opposite sides of the chute member so that said chute member is movably supported by the link members and the chute supporting members, said first end (74) of the chute member being movable towards or away from the discharge end of the conveyor belt; and
a biasing arrangement (130) biasing said first end of the chute member towards said discharge end of the conveyor belt, wherein said first end of the chute member is adapted for mounting a belt scraper transversely relative to the length of the conveyor belt and, during use of the apparatus with said conveyor belt when a belt scraper is mounted on said first end of the chute member, the belt scraper is biased so as to engage and scrape said discharge end of the conveyor belt.

2. A discharge chute apparatus according to claim 1 characterized in that the belt scraper (82) is mounted on said first end (73) of the chute member.

3. A discharge chute apparatus according to claim 1 characterized in that said biasing arrangement (130) includes two elongate coil springs (132, 134) each having one end connected to a respective one of said opposite sides of the chute member (72).

4. A discharge chute apparatus according to any one of claims 1 characterized in that the two link members connected to each supporting member are parallel links.

5. A discharge chute apparatus according to any one of claims 1 characterized in that said chute member (72) includes a metal central panel (86) adapted to slope downwardly from the discharge end of the conveyor belt and two metal side panels (88, 90) rigidly connected to opposite sides of said central panel, and said two link members (104, 106) are pivotally connected to an upper edge section of a respective one of the side panels.

6. A discharge chute apparatus according to any one of claims 1 characterized in that each chute supporting member (100, 102) includes an elongate supporting arm made of spaced-apart inner and outer plates rigidly connected together and said plates support pivot pins to which said two link members are connected.

7. A discharge chute apparatus according to claim 2 characterized in that said belt scraper is a single elongate scraper blade having a length equal to at least a major portion of the width of the conveyor belt.

8. A discharge chute apparatus according to claim 1 characterized by two chute extension inserts (150, 152) mountable adjacent said opposite sides of the chute member (72) and close to said discharge end of said conveyor belt (12).

9. A discharge chute apparatus according to claim 8 characterized in that each chute extension insert (150, 152) is made of rubber and has a major planar portion (154) that extends over part of an inner surface of an adjacent side wall of the chute member (72).

10. A discharge chute apparatus according to claim 8 characterized in that the belt scraper (82) is mounted on said first end (74) of the chute member and extends between and below the two chute extension inserts (150, 152).

11. A discharge chute and belt scraper combination for use at a head pulley end of a conveyor belt movably mounted on a belt support structure, said combination comprising:
a chute member (72) having a receiving end (74) and an opposite discharge end and opposite sides, said receiving end being adapted for mounting adjacent said head pulley end of the conveyor belt;
a belt scraper (82);
chute supporting members (100, 102) arranged at said opposite sides of said chute member and adapted for mounting on said belt support structure, said combination characterized by movable link means (104, 106) for pivotably connecting each of said opposite sides of the chute member to a respective one of the chute supporting members, whereby the receiving end of the chute member is movable towards or away from the head pulley end of the conveyor belt; and
spring means (130) for biasing said receiving end of the chute member and the belt scraper towards said head pulley end of the conveyor belt during use of the combination so that the belt scraper scrapes the conveyor belt at said head pulley end, said belt scraper being mounted on said receiving end so that during use of the combination the scraper extends substantially across the width of the conveyor belt.

12. A discharge chute and belt scraper combination according to claim 11 characterized in that said movable link means include a pair of parallel link members (104, 106) on each of said opposite sides of the chute member, each link member being pivotally connected at one end to the adjacent side of the chute member (72) and being pivotably connected at its other end to its respective chute supporting member (100, 102).

13. A discharge chute and belt scraper combination according to claim 11 characterized in that said spring means comprises two elongate coil springs (130, 132) located on opposite sides of the chute member, each coil spring being operably connected at one end thereof to said chute member and connectible at the other end thereof to said belt support structure.

14. A discharge chute and belt scraper combination according to any one of claims 11 characterized in that said chute member includes a central panel (86) adapted to slope downwardly from said head pulley end during use of said combination and two side panels (88, 90) connected to opposite sides of said central panel, said link means (104, 106) being pivotably connected to upper edge sections of said side panels.

15. A discharge chute and belt scraper combination according to any one of claims 11 characterized by two flexible chute extension inserts (150, 152) mountable adjacent said opposite sides of the chute member (72) close to said head pulley end of the conveyor belt.

16. A belt-type conveyor apparatus for conveying a material such as coal, said apparatus comprising:
an endless loop conveyor belt (12);
a conveyor belt support structure including an elongate supporting frame (16), belt supporting rollers (20) mounted along the length of said supporting frame, and a head pulley (36) rotatably mounted on one end of the support structure, said conveyor belt being mountable on said supporting rollers and extendable around said head pulley;
a discharge chute member (72) having a receiving end (74) adjacent said head pulley and two longitudinal sides;
chute supporting members (100, 102) mounted on said support structure at said one end thereof, said conveyor apparatus characterized by pivotable link members (104, 106) connecting said chute member to the chute supporting members whereby the receiving end of the chute member is movable towards or away from the head pulley; and
a spring arrangement (130) biasing the receiving end of the chute member towards the head pulley, wherein the receiving end of the discharge chute member is adapted for mounting a belt scraper and, during use of said conveyor apparatus with a belt scraper mounted on the receiving end of the chute member, the belt scraper is able to scrape the conveyor belt.

17. A belt-type conveyor apparatus according to claim 16 characterized by an elongate belt scraper (82) mounted rigidly on said chute member (72) at said receiving end.

18. A belt-type conveyor apparatus according to claim 16 characterized in that said link members (104, 106) include two pairs of parallel link members, each pair located on a respective one of the two longitudinal sides of the chute member and each link member being pivotably connected at one end to the adjacent longitudinal side of the chute member and pivotably connected at its other end to its respective chute supporting member.

19. A belt-type conveyor apparatus according to any one of claims 16 characterized in that said spring arrangement (130) includes two coil springs (132, 134) located on opposite sides of the said chute member (72) and outside of the chute member.

20. A belt-type conveyor apparatus according to any one of claims 16 characterized by two chute extension inserts (150, 152) mounted on an end section of the support structure and located adjacent opposite ends of the head pulley (36).

21. A belt type conveyer apparatus according to claim 19 characterized in that said spring arrangement further includes two threaded rod connectors (140) each connected to one end of a respective one of the coil springs and also adjustably connected to said support structure, each of said connectors being usable to apply a desired tension to its respective coil spring.
